(19) United States
(12) Patent Application Publication
(10) Pub. No.: US 2013/0136461 A1
(43) Pub. Date: May 30, 2013

(54) FIXING DEVICE AND IMAGE FORMING APPARATUS USING BELT INCLUDING RESISTANCE HEATER LAYER

(71) Applicant: Toshiyuki SAKAI, Shinshiro-shi (JP)

(72) Inventor: Toshiyuki SAKAI, Shinshiro-shi (JP)

(21) Appl. No.: 13/689,035

(22) Filed: Nov. 29, 2012

(30) Foreign Application Priority Data
Nov. 30, 2011 (JP) 2011-261595

(51) Int. Cl. G03G 15/00; G03G 15/20

(52) U.S. Cl. CPC G03G 15/70; G03G 15/2064
USPC 399/18

(57) ABSTRACT

Fixing device including: belt formed in endless shape and including resistance heater layer and annular electrodes provided on circumferential surface of resistance heater layer; pressing member pressed against belt to form nip through which sheet passes; electricity supplying members that, when in contact with electrodes, supply electricity to resistance heater layer; supporting member provided on opposite side of belt from electricity supplying members and supporting belt from inner circumferential side; displacement mechanism displacing electricity supplying members between first position in contact with electrodes, and second position separated away from electrodes; driving unit driving belt to rotate; driving controlling unit controlling rotation of belt and displacement of electricity supplying members; and trouble detecting unit detecting trouble while sheet is passing through nip. When trouble is detected, driving controlling unit controls driving unit to stop belt from rotating, and displacement mechanism to displace electricity supplying members to second position.

This application is based on application No. 2011-261595 filed in Japan, the contents of which are hereby incorporated by reference.

### BACKGROUND OF THE INVENTION

(1) Field of the Invention

The present invention relates to a fixing device and an image forming apparatus using the fixing device, and specifically to a technology for preventing, in the fixing device, deterioration of a belt that includes a resistance heater layer.

(2) Description of Related Art

In recent years, a fixing device using a belt, which includes a resistance heater layer that emits Joule heat, is used in an image forming apparatus such as a printer or a copier (see, for example, Japanese Patent Application Publication No. 2009-109997).

In general, the fixing device is structured such that electricity is supplied to the resistance heater layer by causing an electricity supplying member connected to an external power source to be in sliding contact with a circumferential surface of the belt.

FIG. 9 is a schematic diagram illustrating the structure of the fixing device including the electricity supplying member.

As illustrated in FIG. 9, a fixing device 900 includes: a belt 951 having an endless shape and including a resistance heater layer; a pressure roller 952 provided inside the belt 951; a pressing roller 953 pressed against the pressure roller 952 via the belt 951; and an electricity supplying member 954.

The belt 951 is provided with an annular electrode E that supplies electricity to the resistance heater layer, and the electricity supplying member 954, which is connected to an external power source (not illustrated), is in sliding contact with a circumferential surface of the annular electrode E.

The electricity supplying member 954 is urged toward the pressure roller 952 by an urging member such as a spring (not-illustrated) in a direction indicated by an arrow F, with the belt 951 being sandwiched by the electricity supplying member 954 and the pressure roller 952. This provides good contact between the belt 951 and the electricity supplying member 954.

However, with the structure of the conventional fixing device 900, when, for example, a trouble like a paper jam occurs as illustrated in FIG. 10 and the user pulls a sheet S in a direction G to remove it from a nip N, a part of the belt 951 contacting the sheet S is moved by the frictional force with the sheet S, while the belt 951 is restricted from moving at a position where it contacts the electricity supplying member 954 by the frictional resistance, thus the belt 951 (annular electrode E) is bent and deformed between the electricity supplying member 954 and the nip N. This may cause a deforming portion e1 of the annular electrode E to be bent or damaged by a corner K of the electricity supplying member 954.

With the damage, the surface of the annular electrode E becomes uneven, and a small gap is generated between the surface of the annular electrode E and the electricity supplying member 954. The gap degrades the contact between the surface of the annular electrode E and the electricity supplying member 954. Also, a spark may occur in the gap and deteriorate the belt 951.

### SUMMARY OF THE INVENTION

The present invention has been conceived in light of the above problems, and it is an object thereof to provide a fixing device and an image forming apparatus that practicably prevent a belt from being damaged when a trouble such as a paper jam is handled, and increase the life of the belt compared with conventional devices.

The above object is fulfilled by a fixing device comprising: a belt formed in an endless shape and including a resistance heater layer and a pair of annular electrodes provided on a circumferential surface of the resistance heater layer; a pressing member configured to be pressed against an outer circumferential surface of the belt to form a nip through which a sheet with an unfixed image formed thereon passes; a pair of electricity supplying members configured to, when being respectively in contact with the pair of annular electrodes, supply electricity from an external power source to the resistance heater layer; a supporting member provided on an opposite side of the belt from the pair of electricity supplying members and supporting the belt from an inner circumferential side of the belt; a displacement mechanism configured to displace the pair of electricity supplying members between a first position to be in contact with the pair of annular electrodes, and a second position to be separated away from the pair of annular electrodes; a driving unit configured to drive the belt to rotate; a driving controlling unit configured to control rotation of the belt via the driving unit, and control displacement of the pair of electricity supplying members via the displacement mechanism; and a trouble detecting unit configured to detect a trouble when the trouble occurs while the sheet is passing through the nip, wherein when the trouble detecting unit detects the trouble, the driving controlling unit controls the driving unit to stop the belt from rotating, and controls the displacement mechanism to displace the pair of electricity supplying members to the second position.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic view illustrating the structure of a printer in an embodiment of the present invention;

FIG. 2 is a perspective view of the fixing section included in the printer seen from below;

FIG. 3 is a partial cross-sectional view illustrating the layered structure of a fixing belt;

FIGS. 4A and 4B are schematic front views of the fixing section when viewed from the front direction of the printer; FIG. 4A indicates a state where the electricity supplying members have been displaced to a first position P1 where the electricity supplying members are pressed against the fixing belt; FIG. 4B indicates a state where the electricity supplying members have been displaced to a second position P2 where the electricity supplying members are separated away from the fixing belt;

FIG. 5 is a block diagram illustrating the structure of a controller and the relationship between the controller and the structural elements targeted to be controlled by the controller;

FIG. 6 is a flowchart illustrating the procedure of the recession process following upon detection of paper jam;

FIG. 7 is a flowchart illustrating the procedure of the restoration process after removal of paper jam;

FIG. 8A illustrates a state where a recording sheet stuck in the fixing nip is pulled and the fixing belt is tilted with respect to the rotational axis of the pressing roller; FIG. 8B illustrates a state where an electricity supplying member is pressed against the tilted fixing belt;

FIG. 9 is a schematic diagram illustrating the structure of a conventional fixing device; and

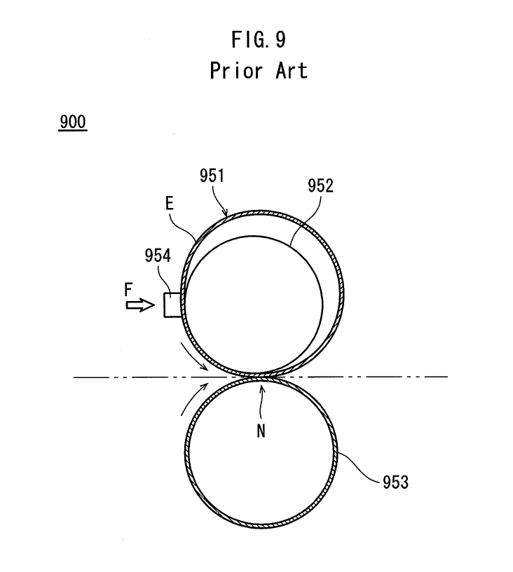

FIG. 10 illustrates a state where a paper jam occurs and a sheet S is pulled to be removed.

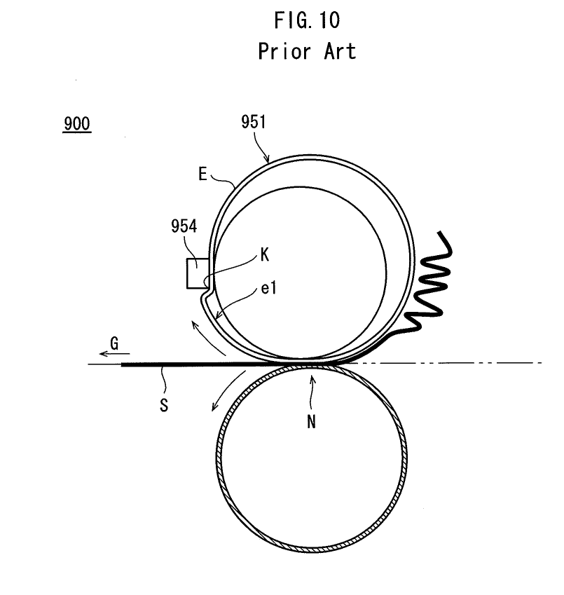

### DESCRIPTION OF THE PREFERRED EMBODIMENTS

### Embodiment

The following describes a tandem-type color printer (hereinafter referred to merely as “printer”) as an embodiment of the image forming apparatus of the present invention, with reference to the attached drawings.

### <Whole Structure of Printer>

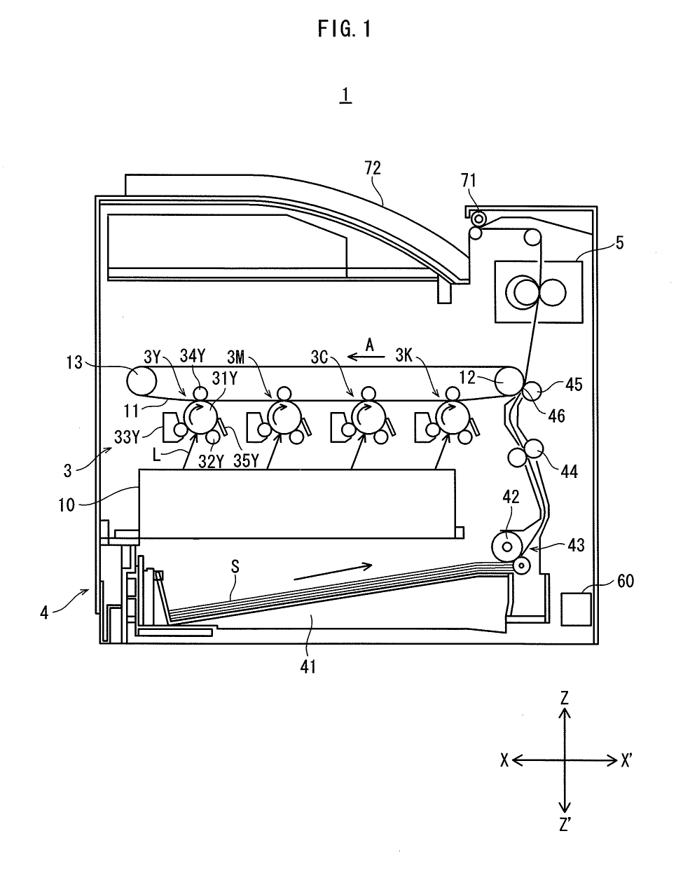

FIG. 1 is a schematic view illustrating the structure of the printer.

As illustrated in FIG. 1, a printer 1 includes an image processing section 3, a paper feed section 4, a fixing section 5, and a controller 60. The printer 1, connected to a network (for example, LAN), is structured to, upon receiving an instruction to execute a print job from an external terminal device (not illustrated), execute the print job by forming toner images of respective colors (yellow, magenta, cyan, and black), forming a color image by transferring the toner images onto an intermediate transfer member by a multi-transfer, and printing the color image onto a recording sheet.

Hereinafter, the reproduction colors yellow, magenta, cyan, and black are represented as Y, M, C, and K, respectively, and the Y, M, C, and K will be added to the reference numbers of the elements related to the colors.

The image processing section 3 includes image creating sections 3Y, 3M, 3C and 3K corresponding to the colors Y, M, C and K, respectively, an optical section 10, and an intermediate transfer belt 11.

The image creating section 3Y includes a photosensitive drum 31Y, and around the photosensitive drum 31Y, a charger 32Y, a developing unit 33Y, a first transfer roller 34Y, and a cleaner 35Y for cleaning the photosensitive drum 31Y. The image creating section 3Y forms a toner image of color Y on the photosensitive drum 31Y. The other image creating sections 3M to 3K have the same structure as the image creating section 3Y, and the reference signs of the structural elements of the other image creating sections are omitted in FIG. 1.

The intermediate transfer belt 11 is a belt having an endless shape and suspended with a tension between a driving roller 12 and a passive roller 13, and is driven to move cyclically in the direction indicated by an arrow A.

The optical section 10 includes light-emitting elements such as laser diodes, and in accordance with a driving signal from the controller 60, emits laser beams L for forming images of colors Y to K to perform an exposure scan on the surfaces of the photosensitive drums 31Y to 31K.

With this exposure scan, an electrostatic latent image is formed on each of the photosensitive drums 31Y to 31K that have been electrically charged by the chargers 32Y to 32K.

The electrostatic latent images are developed by the developing units 33Y to 33K, and toner images of colors Y to K are formed on the photosensitive drums 31Y to 31K, respectively.

The formed toner images are transferred, as a first transfer, onto the intermediate transfer belt 11 by an electrostatic force created by a voltage applied to the first transfer rollers 34Y to 34K. In this first transfer, the creations of images by the image creating sections 3Y, 3M, 3C and 3K are performed at shifted timings so that the images are layered at the same position on the running intermediate transfer belt 11, the timings being shifted from the upstream side toward the downstream side in the running direction of the intermediate transfer belt 11.

The paper feed section 4 includes: a paper feed cassette 41 for housing recording sheets S; a feeding roller 42 for feeding the recording sheets S one by one from the paper feed cassette 41 onto a transport path 43; and a pair of timing rollers 44 for giving timings for sending each recording sheet S fed from the cassette toward a second transfer position 46.

The toner image on the intermediate transfer belt 11 is transferred onto the recording sheet S at the second transfer position 46 by an electrostatic force created by a voltage applied to the second transfer roller 45. This transfer is referred to as a second transfer.

The recording sheet S on which a toner image (unfixed image) has been formed by the second transfer is further transported to the fixing section 5. The toner image on the recording sheet S is heated and pressed in the fixing section 5 and is thermally fixed on the recording sheet S. The recording sheet S is then ejected onto a tray 72 by a pair of ejection rollers 71.

The controller 60 controls the operation of the image processing section 3, paper feed section 4, and fixing section 5.

### <Structure of Fixing Section>

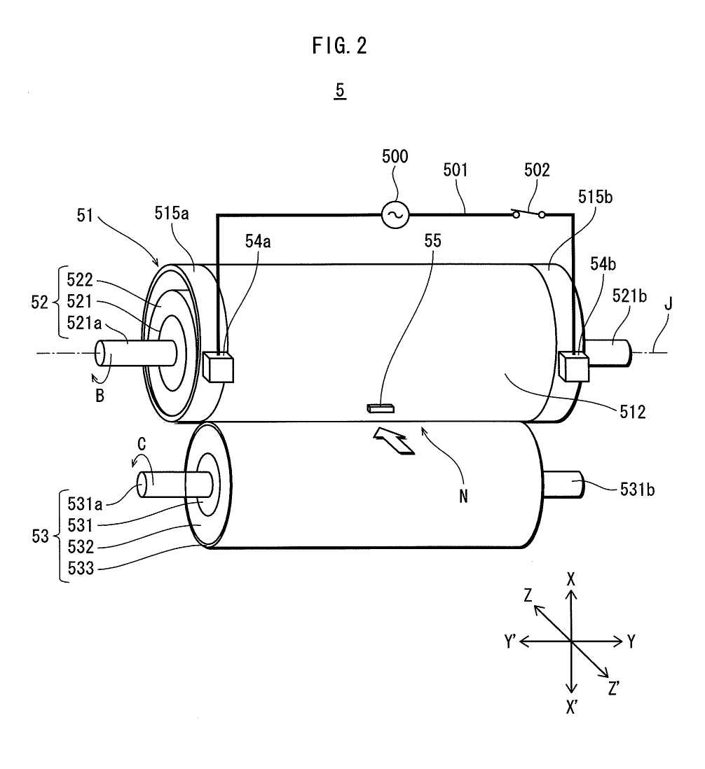

The following describes the structure of the fixing section 5 with reference to FIG. 2.

FIG. 2 is a perspective view of the fixing section 5 seen from below (in the Z direction of FIG. 1).

As illustrated in FIG. 2, the fixing section 5 includes: a fixing belt 51 having an endless shape and including a resistance heater layer 512; a pressure roller 52; a pressing roller 53; electricity supplying members 54a and 54b; and a sheet sensor 55.

The pressure roller 52 is fitted with play in the fixing belt 51 and pressed by the pressing roller 53 via the fixing belt 51. A fixing nip N is formed between the fixing belt 51 and the pressing roller 53 in the above state of pressing each other.

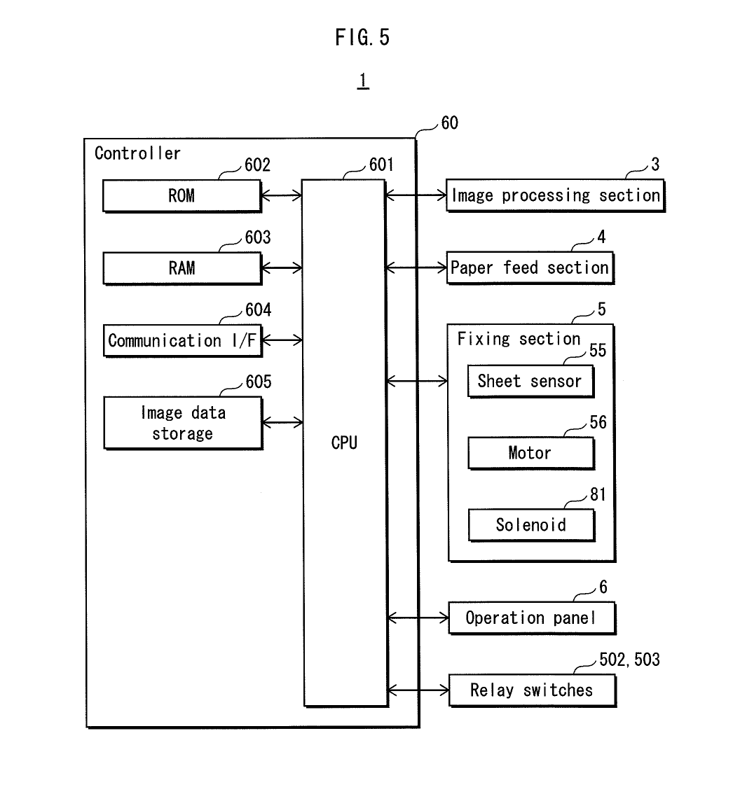

The pressing roller 53 is powered by a motor 56 (Not illustrated in FIG. 2. See FIG. 5), and is driven to rotate via a power transmission mechanism such as gears and/or a belt. The fixing belt 51 and the pressure roller 52 are driven to rotate by following the rotation of the pressing roller 53, and the pressure roller 52 and the pressing roller 53 move together. The pressing roller 53 rotates in the direction indicated by arrow C (see FIG. 2), and the fixing belt 51 and the pressure roller 52 rotate in the direction indicated by arrow B.

The following describes the structural elements of the fixing section 5 in detail.

(Fixing Belt)

The fixing belt 51 is made of a material that can maintain its shape, namely a material that deforms elastically when it receives a certain level of external force in the radius direction, and resumes to the original state by its restoring force when the application of the external force is stopped.

Annular electrode layers 515a and 515b are provided at both ends of the outer circumferential surface of the fixing belt 51 in the width direction. The annular electrode layers 515a and 515b are in contact with electricity supplying members 54a and 54b and receive therefrom a supply of electricity, respectively.

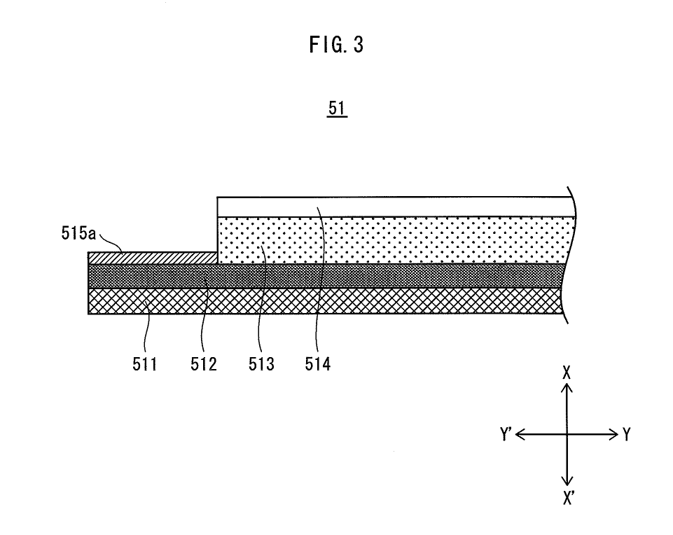

FIG. 3 is a partial cross-sectional view of an end of the fixing belt 51 including the electrode layer 515a, illustrating the layered structure of the fixing belt 51.

As illustrated in FIG. 3, in a region of the fixing belt 51 where no electrode layer is formed, an insulating layer 511, a resistance heater layer 512, an elastic layer 513, and a releasing layer 514 are laminated in the stated order. On the other hand, in a region where the electrode layer is formed, the elastic layer 513 and releasing layer 514 are not formed, but the electrode layer 515a is formed directly on the circumferential surface of the resistance heater layer 512. Note that the other end of the fixing belt 51 including the electrode layer 515b has the same structure.

The insulating layer 511 is made of a heat-resistant resin such as PI (polyimide), PPS (polyphenylenesulfide), or PEEK (polyether ether ketone).

The resistance heater layer 512 is formed by evenly dispersing an electrically conductive filler into a resin material, and emits Joule heat when it receives a supply of electricity. As the resin material, a heat-resistant resin such as PI, PPS, or PEEK may be used. The material of the electrically conductive filler may be a metal, such as silver, copper, aluminum, magnesium, or nickel, or a carbon-based material, such as graphite, carbon black, carbon nanotube, or carbon nanofiber, or a material formed by mixing two or more of these materials and dispersing the mixture. The electrically conductive filler is preferably be shaped in fibrous form to increase the probability of the fillers contacting each other for the same amount of content. The electrical resistivity of the resistance heater layer 512 is preferably in a range from 1.0×10⁻⁶ Ω/m to 1.0×10⁻² Ωm. More preferably, the electrical resistivity of the resistance heater layer 512 may be in a range from 1.0×10⁻⁵ Ωm to 5.0×10⁻³ Ωm.

The elastic layer 513 is made of a rubber or resin material, such as a silicone rubber, that is heat-resistant, elastic, and insulating. The elastic layer 513 provided there prevents a toner image from being crushed or melted unevenly and prevents occurrence of image noise.

The releasing layer 514 is an insulating layer having high releasability from the recording sheet S after the fixing process, and is made of a heat-resistant resin material having high releasability. The resin material for the releasing layer 514 may be a fluoroethylene resin such as PFA (tetrafluoroethylene perfluoroalkoxyethylene copolymer).

The annular electrode layers 515a and 515b are made of, for example, a metal material such as gold, silver, copper, aluminum, zinc, tungsten, nickel, brass, or phosphor bronze. The electrode layers 515a and 515b are each formed in an annular shape by, for example, plating any of the above-mentioned metals along the outer circumferential surface of the resistance heater layer 512. The width of each of the electrode layers 515a and 515b is set to, for example, approximately 15 mm.

The thickness of each of the above-mentioned layers is uniform over the entire circumference. More specifically, the insulating layer 511 is 5 to 100 μm thick, the resistance heater layer 512 is 5 to 200 μm thick, the elastic layer 513 is 100 to 300 μm thick, the releasing layer 514 is 5 to 100 μm thick, and the electrode layers 515a and 515b are each 0.1 to 20 μm thick.

The width of the fixing belt 51 is set to, for example, 360 mm, as a value greater than a sum of the maximum width of the recording sheet S transported on the belt (the shorter side length of A3 sheet) and the widths of the electrode layers 515a and 515b. Also, the inner diameter of the fixing belt 51 is set to 30 mm.

(Pressing Roller)

Back to FIG. 2, the pressure roller 52 is composed of a cored bar 521, which is in a shape of an elongated cylinder, and an elastic layer 522 laminated on the outer circumferential surface of the cored bar 521.

The cored bar 521 is made of, for example, aluminum, iron, or stainless steel, and has shafts 521a and 521b at both ends thereof in the axial direction, the shafts 521a and 521b being rotatably supported by respective bearings provided in a housing (not-illustrated) of the fixing section 5. The elastic layer 522 is made of a highly heat-resistant and heat-insulating material, which is, for example, an elastic foamed material such as a silicone rubber or fluororubber. The elastic layer 522 provided there causes the pressure roller 52 to contact with the fixing belt 51 elastically and have an excellent contact state. Also, since the elastic layer 522 functions as a heat-insulating material as well, it restricts the heat generated in the fixing belt 51 from being released outside via the pressure roller 52. The elastic layer 522 is preferably 1 to 20 mm thick.

In this example, the outer diameter of the cored bar 521 (except for the shafts 521a and 521b) is set to approximately 18 mm, the thickness of the elastic layer 522 is set to approximately 5 mm, and the outer diameter of the pressure roller 52 including these is set to approximately 28 mm, which is smaller than the inner diameter of the fixing belt 51. Furthermore, the length of the pressure roller 52 except for the shafts 521a and 521b is the same as the width of the fixing belt 51.

(Pressure Roller)

The pressing roller 53 is composed of a cored bar 531, which is in a shape of an elongated cylinder, and an elastic layer 532 and a releasing layer 533 which are laminated on the outer circumferential surface of the cored bar 531 in the stated order.

The cored bar 531 is made of, for example, aluminum, iron, or stainless steel, and has shafts 531a and 531b at both ends thereof in the axial direction, the shafts 531a and 531b being rotatably supported by respective bearings provided in a housing (not-illustrated) of the fixing section 5. The elastic layer 532 is made of, for example, a silicone rubber, and the releasing layer 533 is made of, for example, a fluorine-base resin such as PFA. The elastic layer 532 provided there causes the pressing roller 53 to contact with the fixing belt 51 elastically and have an excellent contact state.

The elastic layer 532 is preferably 1 to 20 mm thick, and the releasing layer 533 is preferably 5 to 100 μm thick. Also, the outer diameter of the pressing roller 53 including the elastic layer 532 and the releasing layer 533 is preferably 20 to 100 mm.

In this example, the outer diameter of the cored bar 531 (except for the shafts 531a and 531b) is set to approximately 30 mm, and the thickness of the elastic layer 532 is set to approximately 3 mm. Furthermore, the length of the pressing roller 53 except for the shafts 531a and 531b is set to 330 mm, as a value greater than the maximum width of the recording sheet S transported on the belt, and preventing the pressing roller 53 from contacting the electrode layers 515a and 515b.

(Electricity Supplying Members)

Each of the electricity supplying members 54a and 54b is a block-shaped carbon brush made of a material that is slidable and electrically conductive, such as copper graphite or carbon graphite, and its dimensions are set, for example, as follows: the vertical length is 10 mm (Y-axis direction); the horizontal length is 5 mm (X-axis direction); and the height is 15 mm (Z-axis direction).

The electricity supplying members 54a and 54b are electrically connected to an external power source 500 via a lead wire 501. The power source 500 is, for example, a home power source of a voltage of 100 V at a frequency of 50 Hz or 60 Hz. A well-known relay switch 502 is provided in the lead wire 501 and is switched between ON and OFF under the control of the controller 60 to allow or stop the electricity supply.

Note that the pair of electricity supplying members 54a and 54b and the pair of electrode layers 515a and 515b are each provided as bilaterally symmetrical along a rotational axis J, and thus hereinafter the electricity supplying members 54a and 54b are referred to as “electricity supplying members 54” and the electrode layers 515a and 515b are referred to as “electrode layers 515” unless a distinction therebetween is required.

Each electricity supplying member 54 is held by a displacement mechanism 80, which is described below, in a state of being movable between a first position P1 and a second position P2, wherein at the first position P1, the electricity supplying member 54 is pressed against the electrode layer 515 of the fixing belt 51 by the displacement mechanism 80, and at the second position P2, the electricity supplying member 54 is separated away from the electrode layer 515.

(Displacement Mechanisms for Displacing Electricity Supplying Members)

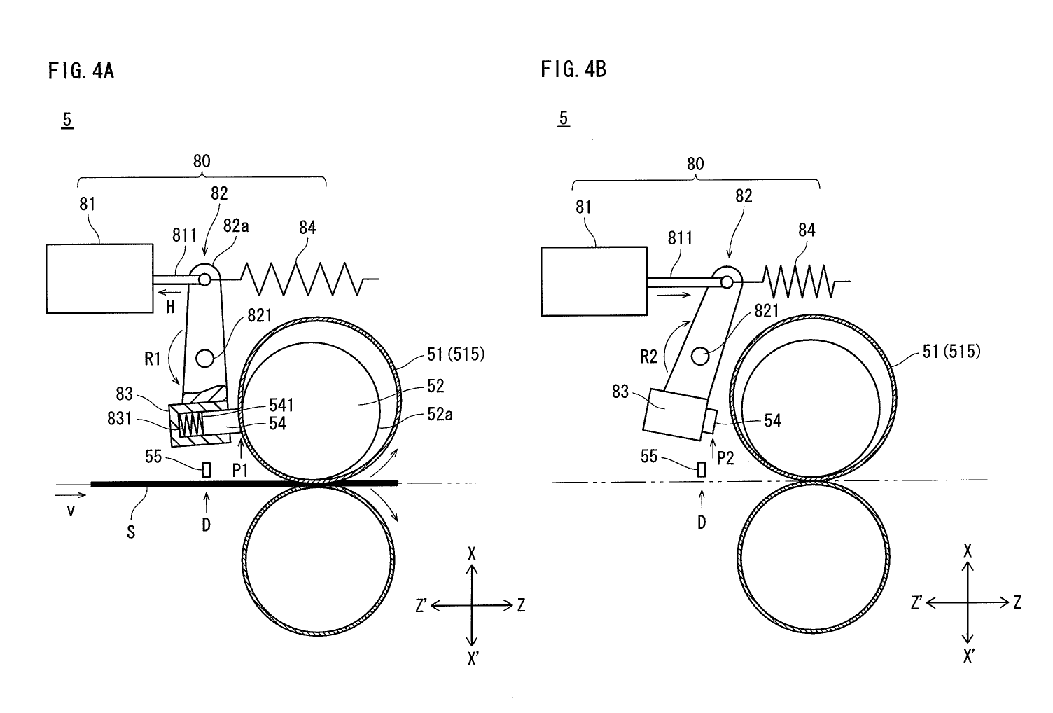

The following describes the structure of displacement mechanisms 80 with reference to FIGS. 4A and 4B.

FIGS. 4A and 4B are schematic front views of the fixing section 5 when viewed from the front direction of the printer 1 (Y′ direction). Note that in FIGS. 4A and 4B, a displacement mechanism 80 and an electricity supplying member 54 located on the front side are illustrated. Note also that FIG. 4A is provided as a partially cutaway sectional view to show the structure of the displacement mechanisms 80 for holding the electricity supplying members 54.

As illustrated in FIG. 4A, each displacement mechanism 80 includes a solenoid 81, a lever 82 that is driven to swing by the solenoid 81, a holder 83 for holding an electricity supplying member 54, and a pull coil spring 84.

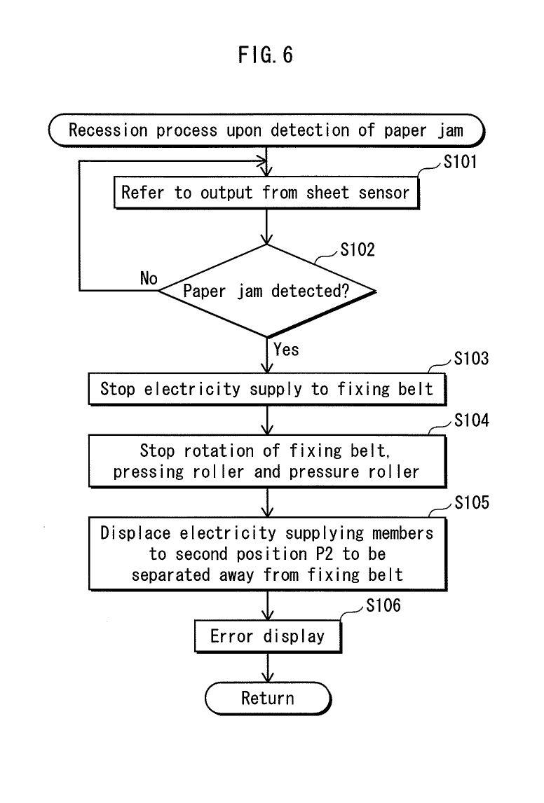

The solenoid 81 is a pull type and includes a plunger 811. The solenoid 81 is driven upon reception of the electricity supply from the power source 500 (see FIG. 2) via the lead wire (not-illustrated). A well-known relay switch 503 (see FIG. 6) is provided in the lead wire, and is switched between ON and OFF under the control of the controller 60 to allow or stop the electricity supply.

The lever 82 is supported by a rotational supporting shaft 821 in a rotatable state. The rotational supporting shaft 821 extends in a direction parallel to the rotational axis J (see FIG. 2) of the pressure roller 52, and is attached to a housing (not illustrated) of the fixing section 5.

The holder 83 has a shape of a cylinder having a bottom. An electricity supplying member 54 is inserted in the holder 83 in a state where it can proceed and recede. A compression coil spring 831 is inserted between the electricity supplying member 54 and the bottom of the holder 83 such that the electricity supplying member 54 is urged toward a corresponding electrode layer 515 of the fixing belt 51 at a first position P1 by a pressing force in a predetermined range.

Note that an end of the compression coil spring 831 is attached to an end surface 541 of the electricity supplying member 54 and the other end of the compression coil spring 831 is attached to the bottom of the holder 83 so that the electricity supplying member 54 does not fall out of the holder 83.

Furthermore, the bottom of the holder 83 is provided with a through hole (not illustrated) through which the lead wire 501 passes and connects to the electricity supplying member 54.

The body of the solenoid 81 and an end of the pull coil spring 84 are respectively attached to a housing (not illustrated) of the fixing section 5, and an end of the plunger 811 of the solenoid 81 and the other end of the pull coil spring 84 are attached to an end 82a of the lever 82, wherein the other end of the lever 82 opposite to the end 82a has the holder 83.

The solenoid 81, when the current flows through it, pulls the plunger 811 in a direction indicated by arrow H, and causes the lever 82 to swing in a direction indicated by arrow R1, resisting an urging force of the pull coil spring 84 that acts in an opposite direction to the direction indicated by the arrow H. This causes the electricity supplying member 54 held by the holder 83 to be displaced to the first position P1 where the electricity supplying member 54 is pressed against the electrode layer 515 of the fixing belt 51. At this time, inside the fixing belt 51, a circumferential surface 52a of the pressure roller 52 is in contact with an inner circumferential surface of the fixing belt 51 and the pressure roller 52 functions as a supporting member for supporting the fixing belt 51 from the inner circumferential side thereof. Also, the compression coil spring 831 urges the electricity supplying member 54 toward the portion of the fixing belt 51 that is supported by the pressure roller 52. This keeps the contact between the electricity supplying member 54 and the electrode layer 515 in an excellent condition.

Note that, in the present embodiment, (i) the relationship in dimension between the outer diameter of the pressure roller 52 and the inner diameter of the fixing belt 51, and (ii) the position where the electricity supplying member 54 presses the fixing belt 51, are determined to satisfy the following conditions: approximately ¼ of the outer circumferential surface of the pressure roller 52 in the circumferential direction from the fixing nip N to the electricity supplying members 54, which is located on the upstream side in the sheet transportation direction, is in contact with the inner circumferential surface of the fixing belt 51, and the remaining, approximately ¾ of the outer circumferential surface of the pressure roller 52 is not in contact with the fixing belt 51.

This is because this structure allows the pressure roller 52 to stably support the fixing belt 51, provides as small a contact area between the pressure roller 52 and the fixing belt 51 as possible, and restricts the heat from being released from the fixing belt 51 via the pressure roller 52.

As illustrated in FIG. 4B, when the driving of the solenoid 81 is stopped, the lever 82 swings in a direction indicated by arrow R2 by the restoring force of the pull coil spring 84, and the electricity supplying member 54 recedes to the second position P2 where the electricity supplying member 54 is separated away from the electrode layer 515 of the fixing belt 51.

(Sheet Sensor)

The sheet sensor 55 is, for example, a reflection-type photoelectric sensor. As illustrated in FIG. 4A, the sheet sensor 55 is provided on the upstream side of the fixing nip N in the sheet transportation direction, and detects the recording sheet S passing a sheet detection position D. The sheet sensor 55 outputs a high-level signal to the controller 60 while it detects the recording sheet S, and outputs a low-level signal to the controller 60 while it does not detect the recording sheet S. The controller 60 judges whether or not the front end or the back end of the recording sheet S has passed the sheet detection position D by detecting a rising edge (a point of change from the low level to the high level) or a falling edge (a point of change from the high level to the low level) in the signal output from the sheet sensor 55.

### <Controller>

FIG. 5 is a block diagram illustrating the structure of the controller 60 and the relationship between the controller 60 and the structural elements targeted to be controlled by the controller 60.

As illustrated in FIG. 5, the controller 60 includes a CPU (Central Processing Unit) 601, a ROM (Read Only Memory) 602, a RAM (Random Access Memory) 603, a communication interface (I/F) 604, and an image data storage 605.

The CPU 601 executes programs for controlling the image processing section 3, paper feed section 4, fixing section 5, operation panel 6 and the like. The

ROM 602 is a storage for storing various types of programs executed by the CPU 601. The RAM 603 is used as a work area by the CPU 601 when it executes a program. The communication I/F 604 is an interface, such as a LAN card or a LAN board, for connecting to a LAN.

The image data storage 605 stores image data for printing which is input via the communication I/F 604 or an image reader (not illustrated).

The operation panel 6 is provided at a position where users can easily operate on an upper portion of the printer 1, and includes: a liquid crystal display on which an operation screen such as a print settings screen is displayed, and various types of information such as a print result are displayed; a touch panel laminated on the liquid crystal display; and operation buttons for inputting various instructions. With this structure, the operation panel 6 receives inputs of various instructions from the user via the touch panel or the operation buttons.

Also, the CPU 601 judges whether or not a paper jam has occurred by checking whether or not the front end and the back end of the recording sheet S have passed the sheet detection position D, and upon detection of a paper jam, the CPU 601 executes a “recession process upon detection of paper jam” which includes controlling the electricity supplying members 54 to recede to the second position P2. After this, when a user or the like removes the recording sheet S stuck in the fixing nip N (hereinafter the process is referred to as “removal of paper jam”) and re-starts the printer 1, the CPU 601 executes a “restoration process after removal of paper jam” to restore the printer 1 to a state where the fixing operation is available.

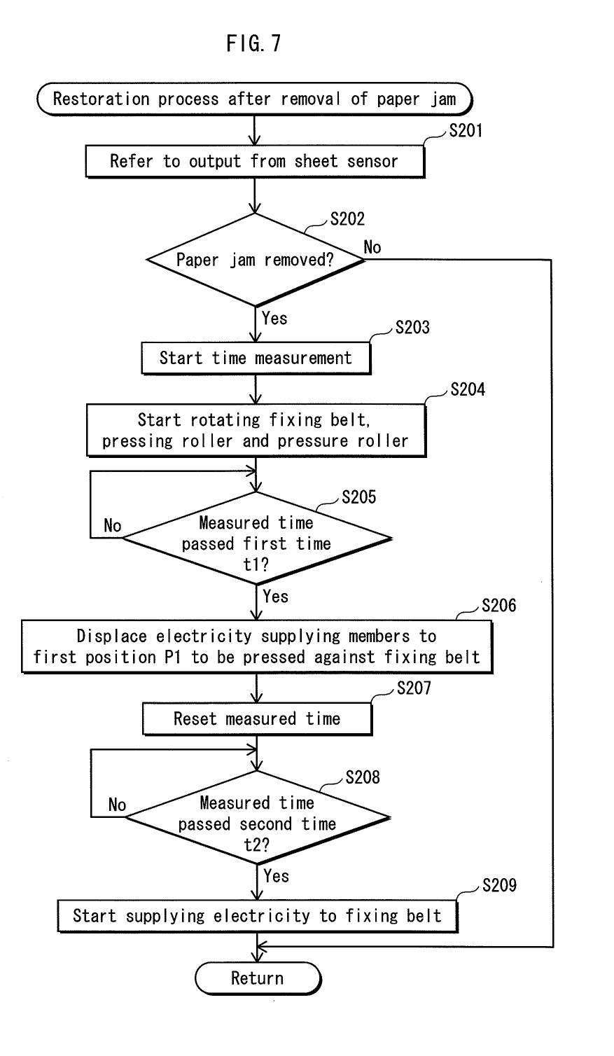

FIG. 6 is a flowchart illustrating the procedure of the “recession process upon detection of paper jam”. FIG. 7 is a flowchart illustrating the procedure of the “restoration process after removal of paper jam”.

Each of these flowcharts is implemented as a subroutine of a main flowchart (not illustrated) that controls the printer 1 as a whole.

### <Recession Process Upon Detection of Paper Jam>

As illustrated in FIG. 6, the controller 60 first refers to an output from the sheet sensor 55 (step S101), and judges whether or not an occurrence of paper jam has been detected (step S102).

An occurrence of a paper jam may be detected as follows.

The controller 60, as described above, can judge whether or not the front end or the back end of the recording sheet S has passed the sheet detection position

D by detecting the rising edge or the falling edge in the signal output from the sheet sensor 55. Here, a time period Ta, a time period between the times when the front end and the back end of the recording sheet S pass the sheet detection position D, can be obtained by using an equation Ta=L/v, where L denotes the length of the recording sheet S in the transport direction, and v denotes the transport speed. Using these judgment and calculation, it is judged that a trouble such as a paper jam has occurred if, for example, it is not detected that the back end of the recording sheet S has passed the sheet detection position D after the time period Ta has passed since it was detected that the front end of the recording sheet S had passed the sheet detection position D.

The length L of the recording sheet S in the transport direction may be obtained by extracting a sheet size from the specification information from the operation panel, or from the header information of the print job. Note that, to prevent an erroneous judgment on paper jam detection, the time period Ta may be slightly longer than the above calculation value.

Also, the sheet sensor 55 may be provided on the downstream side of the fixing nip N in the sheet transportation direction. In this case, it is judged that a paper jam has occurred if, for example, the sheet sensor does not detect the front end of the recording sheet S after a predetermined time period Tb has passed since the pair of timing rollers 44 started to be driven. Here, the time period Tb is obtained by dividing, by the recording sheet transport speed, the distance between the nip of the pair of timing rollers 44 and the detection position of the sheet sensor 55.

When it is judged in step S102 that a paper jam has occurred (Yes), the relay switch 502 (see FIG. 2) is turned off to stop the electricity supply to the fixing belt 51 (step S103), and the motor 56 is stopped from rotating, so that the pressing roller 53 is stopped from rotating and the fixing belt 51 and pressure roller 52 following the pressing roller 53 are stopped from rotating (step S104). In parallel to the operation, to prevent the next recording sheet S from being transported to the fixing section 5, the controller 60 causes the paper feed section 4 to stop from feeding a recording sheet (the feeding roller 42 and the pair of timing rollers 44 are stopped rotating).

Subsequently, the controller 60 turns off the relay switch 503 to stop the driving of the solenoid 81, thereby causing the electricity supplying members 54 to recede to the second position P2 where the electricity supplying members 54 are separated away from the fixing belt 51 (step S105).

The controller 60 then displays an indication of occurrence of a paper jam (an error display) on the operation panel 6 of the printer 1 (step S106), and the control returns to the main flowchart (not illustrated).

Note that when the print job, in which the paper jam has occurred, has been issued by an external terminal, the controller 60 may perform a control to transmit an error message to the external terminal.

Note that although in the above flowchart of the recession process upon detection of paper jam, the process is described in the order of: stopping the electricity supply to the fixing belt 51 (step S103); stopping rotation of the fixing belt 51 and the like (step S104); separation of the electricity supplying member 54 (step S105); and error display (step S106), the processing order is not limited to this.

However, if the separation of the electricity supplying members 54 from the fixing belt 51 is performed while the electricity is supplied to the fixing belt 51, a spark may be generated between the electricity supplying members 54 and the fixing belt 51 immediately after the separation. Thus, as illustrated in the flowchart of FIG. 6, the process of stopping the electricity supply to the fixing belt 51 is preferably performed before the process of separating the electricity supplying member 54 from the fixing belt 51.

<Restoration Process after Removal of Paper Jam>

After the recession process upon detection of paper jam, noticing the error display on the operation panel 6, a user or the like removes the stuck recording sheet (removal of paper jam) and closes the maintenance door, which causes the printer 1 to be re-started. The “restoration process after removal of paper jam” is executed when the printer 1 is re-started in this way.

FIG. 7 is a flowchart illustrating the procedure of the restoration process after removal of paper jam.

As illustrated in FIG. 7, the controller 60 first refers to an output from the sheet sensor 55 (step S201), and judges whether or not a paper jam has been removed (step S202).

In the present embodiment, when the signal output from the sheet sensor 55 indicates that the recording sheet S is not detected, the controller 60 judges that the recording sheet S has been removed and the paper jam has been removed; and when the signal output from the sheet sensor 55 indicates that the recording sheet S is detected, the controller 60 judges that the recording sheet S has not been removed and the paper jam has not been removed.

When it is judged that the paper jam has not been removed (step S202: No), the control returns to the main flowchart (not illustrated), keeping the error display displayed on the operation panel 6.

When it is judged that the paper jam has been removed (step S202: Yes), the controller 60 starts a time measurement (step S203), stops displaying the error display on the operation panel 6, and drives the motor 56 to cause the pressing roller 53, fixing belt 51, and pressure roller 52 to rotate (step S204). At this stage, the electricity supplying members 54 are at the second position P2 where they are separated from the fixing belt 51, and thus the fixing belt 51 is not receiving the supply of electricity.

After this, when the measured time passes a first time t1 (step S205: Yes), the controller 60 drives the solenoids 81 by turning on the relay switch 503 to displace the electricity supplying members 54 to the first position P1, so that the electricity supplying members 54 are pressed against the electrode layers 515 of the fixing belt 51 (step S206). The first time t1 is a time required for the rotations of the fixing belt 51, pressure roller 52, and pressing roller 53, which are started in step S204, to fit to each other, and is set to, for example, several tens of seconds. The first time t1 is determined in advance and is stored in the ROM 602.

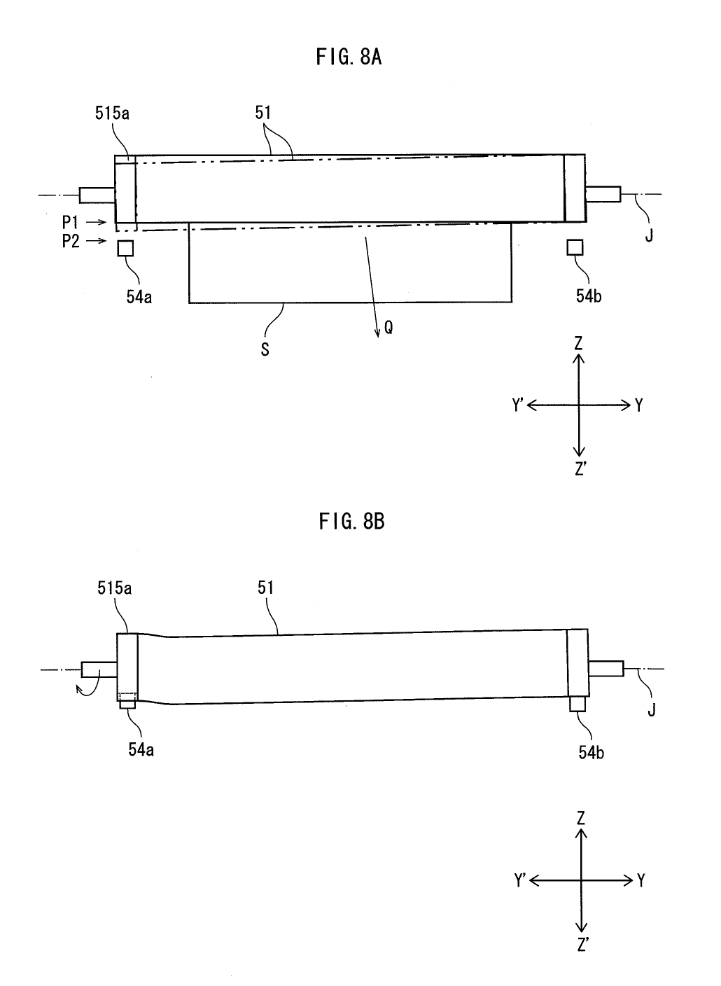

In the removal of paper jam, normally, the user is positioned in front of the printer 1 and removes the recording sheet S stuck in the fixing nip N from a side of the printer 1. Thus, as illustrated in FIG. 8A, the recording sheet S is often pulled in a direction (for example, a direction indicated by arrow Q) that is tilted toward the front of the printer 1 (Y direction) with respect to a direction perpendicular to the rotational axis J. In that case, the fixing belt 51, which is in close contact with the recording sheet S in the fixing nip N, moves together with the recording sheet S and changes the posture from the one indicated by the solid line to the one indicated by the two-dotted chain line which is tilted with respective to the pressure roller 52.

In this tilted state, the distance between the electricity supplying member 54a and the electrode layer 515a is shorter than normal, and the distance between circumferential surfaces of the electrode layer 515a and the pressure roller 52 is greater than normal. As illustrated in FIG. 8B with exaggeration, if the electricity supplying member 54a is displaced from the second position P2 to the first position P1 to press the electrode layer 515a while the fixing belt 51 is tilted in this way, the electrode layer 515a is deformed greatly by the pressing and the surface of the electrode layer 515a may be damaged.

In the present embodiment, to avoid this problem, the fixing belt 51, pressure roller 52, and pressing roller 53 are rotated for a predetermined time period as indicated in step S204 so that their rotations fit to each other and the tilted state of the fixing belt 51 is eliminated before the electricity supplying members 54a and 54b are displaced to the first position P1.

At a timing when the electricity supplying members are pressed against the fixing belt in step S206, the controller 60 resets the measured time to “0” (step S207), and re-starts the time measurement.

After this, when the measured time passes a second time t2 (step S208: Yes), the controller 60 starts supplying the electricity to the fixing belt 51 by turning on the relay switch 502 (step S209). The second time t2 is a time required for the abrasion powder of carbon, which is generated as the pressed electricity supplying members 54 slide with the electrode layers 515, to be stuck on the surfaces of the electrode layers 515 and the contact state between the pressed electricity supplying members 54 and the electrode layers 515 becomes excellent and stable, and is set to, for example, five to six minutes. The second time t2 is also determined in advance and is stored in the ROM 602.

With this structure, if the abrasion powder, which had been stuck on the surfaces of the electrode layers 515 due to sliding with the pressed electricity supplying members 54 before the paper jam occurred, is wiped away by the recording sheet, the contact state between the electricity supplying members 54 and the electrode layers 515 is resumed to the excellent state before the re-start and is always kept to be excellent after the re-start.

After this, the control returns to the main flowchart (not illustrated). In the main flowchart, a warm-up process for increasing the temperature of the fixing belt 51 to a predetermined fixing temperature and other processes are executed.

As described above, the fixing section 5 of the present embodiment is structured such that, when an occurrence of a trouble such as a paper jam is detected while the recording sheet is passing through the fixing nip N, the controller 60 stops driving the motor 56 to stop the rotation of the fixing belt 51, and at the same time, controls the displacement mechanism 80 to cause the electricity supplying members 54 to recede to the second position P2 where the electricity supplying members 54 are separated away from the electrode layers 515.

With this structure, even if the user performs the removal of paper jam or the like and pulls off the recording sheet caught in the fixing nip N, and the fixing belt 51 moves together with the recording sheet to change its posture, the fixing section 5 is immune to the problem where an electrode layer 515 of the fixing belt 51 is bent and deformed between an electricity supplying member 54 and the fixing nip N and the electrode layer 515 is damaged by a strong force generated by the deformed belt.

As a result, the structure of the present embodiment eliminates the occurrence of a spark between the electricity supplying member 54 and the electrode layer 515 that has been observed conventionally due to the damage of the fixing belt 51 which is caused by a removal of paper jam, and thus the present invention increases the life of the fixing belt 51.

Note that, the controller 60 in the present embodiment functions as the controlling units of the present invention when it performs corresponding steps illustrated in FIGS. 6 and 7. For example, the controller 60 functions as the “driving controlling unit” of the present invention when the controller 60 executes steps S104 and S105 of FIG. 6 and steps S204 and S206 of FIG. 7, and functions as the “electricity supply controlling unit” when the controller 60 executes step S103 of FIG. 6 and step S209 of FIG. 7.

Also, the controller 60 functions as the “trouble detecting unit” when the controller 60 executes steps S101 and S102 of FIG. 6 based on a detection result of the sheet sensor 55, and functions as the “trouble elimination detecting unit” when the controller 60 executes steps S201 and S202 of FIG. 7.

### [Modifications]

Up to now, the present invention has been described based on the embodiment. However, the present invention is not limited to the above-described embodiment, but may be modified as follows, for example.

(1) In the above embodiment, the displacement mechanism 80 is described as adopting the solenoid mechanism. However, the present invention is not limited to this structure.

For example, a direct-acting motor or an eccentric cam may be used to selectively displace the electricity supplying members 54 between the first position P1 and the second position P2.

(2) The size, shape, position and the like of the electricity supplying members are not limited to those provided in the above embodiment. For example, the block-shaped electricity supplying members that slide with the electrode layers may be replaced with electricity supplying rollers that contact the electrode layers while rotating.

This is because the electricity supplying rollers are also preferably displaced to the second position P2 separated away from the fixing belt (electrode layers) because, although they have a small frictional resistance, as long as they press the fixing belt locally, the electrode layers may be bent and damaged at the position where they are pressed by them, depending on the speed, size and direction of the force applied when the user pulls off the recording sheet.

Also, in the above embodiment, the electricity supplying members 54 are provided on the upstream side of the fixing nip N in the rotational direction of the fixing belt 51. However, not limited to this, the electricity supplying members 54 may be pressed against the circumferential surface of the pressing roller at the downstream side of the fixing nip N. This is because it is not predictable from which direction, the upstream side or the downstream side, the user might pull off the recording sheet.

(3) In the above embodiment, a paper jam is described as one example of a trouble that may occur while the recording sheet is passing through the fixing nip N. However, the present invention is not limited to this structure.

For example, there may be a case where the safety device is activated and a printing operation is suddenly stopped because the user carelessly opened the maintenance door during the printing operation, or there may be a case where a fixing operation is stopped because a trouble is detected when a high temperature due to abnormality in the heater or in the temperature sensor is detected, or an operation is forcibly stopped due to detection of a low temperature. In such cases, if the recording sheet remains in the fixing nip N, the displacement mechanism 80 may be controlled to displace the electricity supplying members 54 to the second position P2 where the electricity supplying members 54 are separated away from the electrode layers 515. This prevents the electrode layers 515 of the fixing belt 51 from contacting the electricity supplying members 54 and being damaged. Accordingly, the present modification produces the same advantageous effects as the above embodiment.

Also, not limited to the case where an occurrence of a trouble is detected, in almost all cases where the fixing operation is stopped, the electricity supplying members 54 may be controlled to be displaced to the second position P2.

(4) In the above embodiment, the fixing belt 51 has a layered structure in which an insulating layer, a resistance heater layer, an elastic layer, and a releasing layer are laminated in the stated order. However, the present invention is not limited to this structure. The structure of the fixing belt and thicknesses of the layers may be determined appropriately within the specifications of the fixing section.

(5) In the above embodiment, the pressing roller 53 is driven by the motor 56 to rotate, and the pressure roller 52 is driven to rotate by following the rotation of the pressing roller 53. However, the present invention is not limited to this structure.

For example, the pressure roller 52 may be driven by a motor to rotate, and the pressing roller 53 may be driven to rotate by following the rotation of the pressure roller 52. As another example, both the pressure roller 52 and the pressing roller 53 may be driven by a motor to rotate.

(6) In the above embodiment, the pressure roller 52 is fitted with play in the fixing belt 51 as a supporting member for supporting the fixing belt 51 from the inner side thereof. However, the present invention is not limited to this structure. For example, instead of the pressure roller 52, an elongated pad contacting the inner circumferential surface of the fixing belt 51 may be used as the supporting member.

In that case, the pressing roller 53 may be pressed against the pad via the fixing belt 51 to form the fixing nip N, and the fixing belt 51 may be sandwiched by the pad (or another supporting member provided independently of the pad) and the electricity supplying members 54. With this structure, the present modification produces the same advantageous effects as the above embodiment.

(7) In the above embodiment, the pressing roller 53 is pressed against the pressure roller 52 via the fixing belt 51 to form the fixing nip N. However, the present invention is not limited to this structure. For example, instead of the pressing roller 53, an elongated pad having a sliding surface that is slid with the outer circumferential surface of the fixing belt 51 may be used as the pressing member.

(8) The present invention may also be applied to a structure where a fixing belt is fitted without play to the outer circumferential surface, which includes an elastic layer, of a pressing roller. The application of the present invention eliminates a possibility that, when a recording sheet is pulled off, the elastic layer is deformed and the fixing belt is bent, and an electrode layer is damaged. Thus, application of the present invention to this structure increases the life of the belt compared with the conventional structure.

(9) In the above embodiment, in the restoration process after removal of paper jam, after the fixing belt and other members start to be driven, step S205 is performed to wait for the first time t1 to pass before a control is performed to press the electricity supplying members against the electrode layers. However, in the case of the above modification (8) or the like, the fixing belt is not likely to be tilted with respect to the pressing roller. Accordingly, in such cases, the step S205 may be omitted.

(10) In the above embodiment, the image forming apparatus is a tandem-type color printer. However, not limited to this, the present invention is applicable to a copier, a facsimile apparatus, a printer or the like that includes a fixing section using a resistance heater.

Furthermore, the above embodiment and modifications may be combined as appropriate as possible.

### <Summary>

The above embodiment and modifications indicate one aspect for solving the problem described in “Description of Related Art” section. The above embodiment and modifications are summarized as follows.

A fixing device comprising: a belt formed in an endless shape and including a resistance heater layer and a pair of annular electrodes provided on a circumferential surface of the resistance heater layer; a pressing member configured to be pressed against an outer circumferential surface of the belt to form a nip through which a sheet with an unfixed image formed thereon passes; a pair of electricity supplying members configured to, when being respectively in contact with the pair of annular electrodes, supply electricity from an external power source to the resistance heater layer; a supporting member provided on an opposite side of the belt from the pair of electricity supplying members and supporting the belt from an inner circumferential side of the belt; a displacement mechanism configured to displace the pair of electricity supplying members between a first position to be in contact with the pair of annular electrodes, and a second position to be separated away from the pair of annular electrodes; a driving unit configured to drive the belt to rotate; a driving controlling unit configured to control rotation of the belt via the driving unit, and control displacement of the pair of electricity supplying members via the displacement mechanism; and a trouble detecting unit configured to detect a trouble when the trouble occurs while the sheet is passing through the nip, wherein when the trouble detecting unit detects the trouble, the driving controlling unit controls the driving unit to stop the belt from rotating, and controls the displacement mechanism to displace the pair of electricity supplying members to the second position.

The above fixing device may further comprise: a trouble elimination detecting unit configured to detect an elimination of the trouble when the trouble is eliminated, wherein when the trouble elimination detecting unit detects the elimination of the trouble, the driving controlling unit controls the driving unit to rotate the belt and controls the displacement mechanism to displace the pair of electricity supplying members to the first position.

In the above fixing device, when the trouble elimination detecting unit detects the elimination of the trouble, the driving controlling unit may first control the driving unit to rotate the belt, then after a first time period passes, may control the displacement mechanism to displace the pair of electricity supplying members to the first position.

The above fixing device may further comprise: an electricity supply controlling unit configured to control supply of electricity from the external power source to the resistance heater layer, wherein when the trouble detecting unit detects the trouble, the electricity supply controlling unit stops supply of electricity to the resistance heater layer, and when the trouble elimination detecting unit detects the elimination of the trouble, the electricity supply controlling unit, only after the displacement mechanism displaces the pair of electricity supplying members to the first position and then, after a completion of the displacement, a second time period passes, starts supply of electricity to the resistance heater layer.

An image forming apparatus comprising a fixing device, the fixing device including: a belt formed in an endless shape, including a resistance heater layer and a pair of annular electrodes provided on a circumferential surface of the resistance heater layer; a pressing member configured to be pressed against an outer circumferential surface of the belt to form a nip through which a sheet with an unfixed image formed thereon passes; a pair of electricity supplying members configured to, when being respectively in contact with the pair of annular electrodes, supply electricity from an external power source to the resistance heater layer; a supporting member provided on an opposite side of the belt from the pair of electricity supplying members and supporting the belt from an inner circumferential side of the belt; a displacement mechanism configured to displace the pair of electricity supplying members between a first position to be in contact with the pair of annular electrodes, and a second position to be separated away from the pair of annular electrodes; a driving unit configured to drive the belt to rotate; a driving controlling unit configured to control rotation of the belt via the driving unit, and control displacement of the pair of electricity supplying members via the displacement mechanism; and a trouble detecting unit configured to detect a trouble when the trouble occurs while the sheet is passing through the nip, wherein when the trouble detecting unit detects the trouble, the driving controlling unit controls the driving unit to stop the belt from rotating, and controls the displacement mechanism to displace the pair of electricity supplying members to the second position.

In the above image forming apparatus, the fixing device may further include: a trouble elimination detecting unit configured to detect an elimination of the trouble when the trouble is eliminated, wherein when the trouble elimination detecting unit detects the elimination of the trouble, the driving controlling unit controls the driving unit to rotate the belt and controls the displacement mechanism to displace the pair of electricity supplying members to the first position.

In the above image forming apparatus, when the trouble elimination detecting unit detects the elimination of the trouble, the driving controlling unit may first control the driving unit to rotate the belt, then after a first time period passes, may control the displacement mechanism to displace the pair of electricity supplying members to the first position.

In the above image forming apparatus, the fixing device may further include: an electricity supply controlling unit configured to control supply of electricity from the external power source to the resistance heater layer, wherein when the trouble detecting unit detects the trouble, the electricity supply controlling unit stops supply of electricity to the resistance heater layer, and when the trouble elimination detecting unit detects the elimination of the trouble, the electricity supply controlling unit, only after the displacement mechanism displaces the pair of electricity supplying members to the first position and then, after a completion of the displacement, a second time period passes, starts supply of electricity to the resistance heater layer.

With the above-described structure, when a trouble occurs while a sheet is passing through the nip, the electricity supplying members are displaced to the second position to be separated away from the annular electrodes of the belt. Thus, if the user pulls off the sheet from the nip and the belt is pulled together with the sheet and tilted, the annular electrodes are prevented from being damaged by the electricity supplying members. This restricts degradation of the contact state and generation of a spark, and increases the life of the belt compared with the conventional structure.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A fixing device comprising:
a belt formed in an endless shape and including a resistance heater layer and a pair of annular electrodes provided on a circumferential surface of the resistance heater layer;
a pressing member configured to be pressed against an outer circumferential surface of the belt to form a nip through which a sheet with an unfixed image formed thereon passes;
a pair of electricity supplying members configured to, when being respectively in contact with the pair of annular electrodes, supply electricity from an external power source to the resistance heater layer;
a supporting member provided on an opposite side of the belt from the pair of electricity supplying members and supporting the belt from an inner circumferential side of the belt;
a displacement mechanism configured to displace the pair of electricity supplying members between a first position to be in contact with the pair of annular electrodes, and a second position to be separated away from the pair of annular electrodes;
a driving unit configured to drive the belt to rotate;
a driving controlling unit configured to control rotation of the belt via the driving unit, and control displacement of the pair of electricity supplying members via the displacement mechanism; and
a trouble detecting unit configured to detect a trouble when the trouble occurs while the sheet is passing through the nip, wherein
when the trouble detecting unit detects the trouble, the driving controlling unit controls the driving unit to stop the belt from rotating, and controls the displacement mechanism to displace the pair of electricity supplying members to the second position.

2. The fixing device of claim 1 further comprising:
a trouble elimination detecting unit configured to detect an elimination of the trouble when the trouble is eliminated, wherein
when the trouble elimination detecting unit detects the elimination of the trouble, the driving controlling unit controls the driving unit to rotate the belt and controls the displacement mechanism to displace the pair of electricity supplying members to the first position.

3. The fixing device of claim 2, wherein
when the trouble elimination detecting unit detects the elimination of the trouble, the driving controlling unit first controls the driving unit to rotate the belt, then after a first time period passes, controls the displacement mechanism to displace the pair of electricity supplying members to the first position.

4. The fixing device of claim 2 further comprising:
an electricity supply controlling unit configured to control supply of electricity from the external power source to the resistance heater layer, wherein
when the trouble detecting unit detects the trouble, the electricity supply controlling unit stops supply of electricity to the resistance heater layer, and when the trouble elimination detecting unit detects the elimination of the trouble, the electricity supply controlling unit, only after the displacement mechanism displaces the pair of electricity supplying members to the first position and then, after a completion of the displacement, a second time period passes, starts supply of electricity to the resistance heater layer.

5. An image forming apparatus comprising a fixing device,
the fixing device including:
a belt formed in an endless shape, including a resistance heater layer and a pair of annular electrodes provided on a circumferential surface of the resistance heater layer;
a pressing member configured to be pressed against an outer circumferential surface of the belt to form a nip through which a sheet with an unfixed image formed thereon passes;
a pair of electricity supplying members configured to, when being respectively in contact with the pair of annular electrodes, supply electricity from an external power source to the resistance heater layer;
a supporting member provided on an opposite side of the belt from the pair of electricity supplying members and supporting the belt from an inner circumferential side of the belt;
a displacement mechanism configured to displace the pair of electricity supplying members between a first position to be in contact with the pair of annular electrodes, and a second position to be separated away from the pair of annular electrodes;
a driving unit configured to drive the belt to rotate;
a driving controlling unit configured to control rotation of the belt via the driving unit, and control displacement of the pair of electricity supplying members via the displacement mechanism; and
a trouble detecting unit configured to detect a trouble when the trouble occurs while the sheet is passing through the nip, wherein
when the trouble detecting unit detects the trouble, the driving controlling unit controls the driving unit to stop the belt from rotating, and controls the displacement mechanism to displace the pair of electricity supplying members to the second position.

6. The image forming apparatus of claim 5, wherein
the fixing device further includes:
a trouble elimination detecting unit configured to detect an elimination of the trouble when the trouble is eliminated, wherein
when the trouble elimination detecting unit detects the elimination of the trouble, the driving controlling unit controls the driving unit to rotate the belt and controls the displacement mechanism to displace the pair of electricity supplying members to the first position.

7. The image forming apparatus of claim 6, wherein
when the trouble elimination detecting unit detects the elimination of the trouble, the driving controlling unit first controls the driving unit to rotate the belt, then after a first time period passes, controls the displacement mechanism to displace the pair of electricity supplying members to the first position.

8. The image forming apparatus of claim 6, wherein
the fixing device further includes:
an electricity supply controlling unit configured to control supply of electricity from the external power source to the resistance heater layer, wherein
when the trouble detecting unit detects the trouble, the electricity supply controlling unit stops supply of electricity to the resistance heater layer, and when the trouble elimination detecting unit detects the elimination of the trouble, the electricity supply controlling unit, only after the displacement mechanism displaces the pair of electricity supplying members to the first position and then, after a completion of the displacement, a second time period passes, starts supply of electricity to the resistance heater layer.
